(19) United States
(12) Patent Application Publication
(10) Pub. No.: US 2017/0176371 A1
(43) Pub. Date: Jun. 22, 2017

(54) METHOD AND DEVICE FOR PRODUCING A REFERENCE ELECTRODE

(71) Applicant: Endress+Hauser Conducta GmbH+Co. KG, Gerlingen (DE)

(72) Inventors: Michael Hanko, Dresden (DE); Stefanie Jahn, Waldheim (DE); Jens Vettermann, Grossweitzschen (DE)

(21) Appl. No.: 15/381,357

(22) Filed: Dec. 16, 2016

(30) Foreign Application Priority Data
Dec. 21, 2015 (DE) 10 2015 122 454.2

(51) Int. Cl. G01N 27/30; C03B 23/00; G01N 27/416

(52) U.S. Cl. CPC G01N 27/301; G01N 27/4161; C03B 23/006; B29C 65/16

(57) ABSTRACT

The present disclosure relates to a method for producing a reference electrode, wherein an internal space of the reference electrode is delimited by an outer wall and wherein the internal space contains a reference electrolyte up to a specified height, wherein the reference electrode is introduced into a pressurization chamber, wherein a defined overpressure is applied to the pressurization chamber and, via an opening that is located above the specified height in the outer wall of the reference electrode to the internal space of the reference electrode, and wherein the opening in the outer wall of the reference electrode is closed at the defined overpressure . The present disclosure further relates to a device for carrying out the method.

### CROSS-REFERENCE TO RELATED APPLICATION

The present application is related to and claims the priority benefit of German Patent Application No. 10 2015 122 454.2, filed on Dec. 21, 2015, the entire contents of which are incorporated herein by reference.

### TECHNICAL FIELD

The present disclosure relates to a method and a device for producing a reference electrode. The present disclosure further relates to a sensor assembly, particularly a potentiometric single-rod measuring chain, with a reference electrode produced in accordance with the method according to the present disclosure.

### BACKGROUND

Potentiometric sensors are used both in process analytics and in the laboratory for a variety of analytical applications. An important process variable that can be measured by means of potentiometric measuring chains is the pH value, which, for example, plays an important role in environmental analytics and in chemical or biochemical processes. The pH value corresponds to the negative common logarithm of the H⁺ or H₃O⁺ ion activity in a measuring fluid, which is comparable in diluted solutions to the H⁺ or H₃O⁺ ion concentration. Potentiometric sensors can also be used to determine the concentrations of other ions contained in a measuring fluid, such as chloride, nitrate, sodium, potassium, or phosphate.

A potentiometric sensor can comprise, for example, a potentiometric measuring chain, which generally has a measuring half-cell or a measuring electrode and a reference half-cell or a reference electrode. In the case of a pH sensor, the measuring half-cell has a pH-sensitive diaphragm, the surface of which that faces away from the measuring medium is in contact with an inner electrolyte having a buffer system. The pH-sensitive diaphragm is often designed as a glass membrane and, in contact with an aqueous measuring medium, forms a hydrated layer. Depending upon the pH value of the measuring medium, H⁺ ions diffuse either from the hydrated layer or into the hydrated layer. During measuring operation of the measuring half-cell, this diffusion takes place at the surface of the pH-sensitive diaphragm in contact with the measuring medium, as well as that in contact with the inner electrolyte. Since the inner electrolyte has a constant pH value, a potential difference results that depends upon the pH value of the measuring medium. The inner electrolyte is contacted via a deflecting element, which is designed, for example, as a metal wire.

The reference half-cell consists of a deflecting element in the form of an electrode of the second type, for example, which is immersed in a reference electrolyte that determines the potential for the reference half-cell. This reference half-cell ideally provides a reference potential that is independent of the composition of the measuring medium. The reference electrolyte is, for example, in contact with the measuring medium via a diaphragm arranged in the outer wall. In a silver/silver chloride electrode, a chlorinated silver wire is used as deflecting element, and a highly concentrated potassium chloride solution with a molar concentration of, for example, 3 M is used as reference electrolyte. The voltage that can be tapped between the deflecting element of the measuring half-cell and the deflecting element of the reference half-cell, also called pH voltage, recorded by the electronic measuring/evaluation unit, and converted into the pH value of the measuring medium based upon a sensor characteristic curve determined by calibration.

Potentiometric measuring chains of sensors for determining concentrations of ions other than H⁺, which are often called ion-selective electrodes (ISE), also have an analogous structure, wherein the measuring half-cell comprises an ion-sensitive diaphragm appropriate for the ion type. Such measuring chains are also called ion-selective electrodes.

Even though potentiometric sensors provide very precise and reliable measurement results and are well established both in laboratory analytics and in industrial process analytics, they still have disadvantages. For example, measuring medium enters the reference electrolyte via the diaphragm, which, on the one hand, leads to dilution of the reference electrolyte over time, and thus to a change in the reference potential. On the other hand, electrode poisons entering from the measuring medium can also change the reference potential of the deflecting element designed as an electrode of the second type. This effect is necessarily intensified if the external pressure prevailing outside the measuring chain is greater than the internal pressure prevailing in the internal space of the reference electrode.

In order to counteract this problem, reference electrodes can be provided with a connection for the continuous replenishment of electrolyte solution. Using a pressurized storage container arranged next to the reference electrode, electrolyte solution can thus be pushed from the storage container, via the internal space of the reference half-cell or reference electrode and the diaphragm, into the process. Disadvantageous in this case is the considerable effort required for the installation and maintenance of these types of solutions.

In order to minimize the installation and maintenance effort and still ensure a continuous outflow of electrolyte solution from the internal space of the reference half-cell or reference electrode, various designs of pressurized reference electrodes have already become known. In the known solutions, an internal pressure that is generally higher than the maximum external pressure prevailing at the place of installation of the measuring chain is applied to the internal space of the reference electrodes, said internal space comprising a gas-filled volume. By expanding the gas volume in the internal space of such reference half-cells or reference electrodes, the electrolyte is pushed out through the diaphragm after such a pressurized reference electrode is put into operation.

DE 37 02 501A1 describes a pH measuring chain with a pressurized reference electrode for microbiological processes. In the pH measuring chain, above the reference electrolyte, a hollow space is arranged, which contains a pressurized gas that is in contact with the reference electrolyte. A gas supply line, which opens into the hollow space, is mounted on the wall of the electrode housing in a gas-tight manner, and can be closed in a gas-tight manner, is provided for purposes of pressurization. The gas supply line is designed as a platinum capillary tube, which is closed off by clamping with pliers after the gas is supplied. Because of the specific design of the reference electrode, this known solution is technically complex and associated with high costs.

In EP 1 544 608 B1, a method for producing a pressurized reference electrode became known. In this solution, the pressure is applied, not via an additional component, such as the platinum capillary tube described in DE 37 02 501 A1, but via the diaphragm that, as such, is a necessary component of any reference electrode. The diaphragm generally consists of a porous silica or zirconium oxide ceramic. By means of the pressurization of the reference electrode through the forcing in of gas, e.g., air, via the diaphragm, an overpressure of up to 10 bar can be achieved in the reference electrode.

This known solution has the disadvantage that the pressurization is time-consuming and/or that the internal pressure prevailing in the pressurized reference electrode is known to have a relatively large variance. Aside from the fact that a certain variance exists in the reference electrodes, the gas or the air in the known solution do not have unimpeded access to the internal space of the reference electrode. Rather, the gas is forced into the internal space of the reference electrode via the porous ceramic. Then, the air forced in through the porous ceramic must travel through the fluid—typically, thickened—reference electrolyte, in order to apply the desired pressure to the internal space.

### SUMMARY

The present disclosure discloses a method and a device with which a specified pressure can be applied easily and quickly to a reference electrode. The present disclosure further discloses a method for producing a reference electrode, wherein an internal space of the reference electrode is delimited by an outer wall and wherein the internal space contains a reference electrolyte up to a specified height. The reference electrode is introduced into a pressurization chamber; then, a defined overpressure is applied to the pressurization chamber and, via an opening that is located above the specified height in the outer wall of the reference electrode, to the internal space of the reference electrode. The opening in the outer wall of the reference electrode is subsequently closed at the defined overpressure. A plurality of reference electrodes can also be subjected simultaneously to the method according to the present disclosure.

Via the opening in the outer wall of the reference electrode, the same overpressure as in the pressurization chamber is reached very quickly, within a few seconds, in the internal space of the reference electrode. Since the opening is closed under the pressure prevailing in the pressurization chamber, the pressure in the internal space of the reference electrode corresponds to the overpressure prevailing in the pressurization chamber. Since this overpressure can be adjusted as precisely as desired, the overpressure in the internal space of the reference electrode is also well defined.

According to an embodiment of the method according to the present disclosure, the opening in the outer wall of the reference electrode is produced by supplying energy selectively. The opening is preferably produced in the outer wall of the reference electrode by fusing in the pressurization chamber, especially at a point in time when overpressure is not yet applied to the pressurization chamber. The opening can also be introduced into the outer wall during the usual manufacturing process of the reference electrode.

An embodiment of the method according to the present disclosure provides that the opening in the outer wall of the reference electrode be closed by supplying energy selectively. The opening is sealed at the defined overpressure prevailing in the pressurization chamber.

After closing the opening, the pressurization chamber is vented. Preferably, the pressure in the pressurization chamber is reduced to the pressure prevailing in the surroundings of the pressurization chamber.

In a further embodiment of the method according to the present disclosure, the opening in the outer wall of the reference electrode be produced or closed by thermal fusion or melt-sealing respectively by means of laser radiation or in the flame.

The reference electrode produced in accordance with the method according to the present disclosure may be used in a sensor assembly, including in a potentiometric, single-rod measuring chain. The potentiometric sensor assembly may be used to measure or monitor the pH value of a measuring medium. The reference electrode and the measuring electrode are electrodes made of glass or plastic. The reference electrode to be pressurized can be fused at the end region facing away from the measuring medium, or the end region is closed in a gas-tight manner by means of another component.

In order to perform the above-described method according to the present disclosure and its advantageous developments, a device is used that has the following components: a pressurization chamber with a housing, a pressure supply, via which the overpressure in the pressurization chamber can be adjusted, and a laser that is arranged and/or focused such that the opening of the pressurized reference electrode is produced and/or closed by means of laser radiation.

In this connection, a preferred solution provides that the laser be arranged outside the housing of the pressurization chamber. In order for the laser radiation to enter through the wall of the housing in an unimpeded manner, at least one section of the housing of the pressurization chamber is produced from a material that is transparent to the laser radiation produced by the laser. Alternatively, it is further provided that the laser be arranged inside the housing of the pressurization chamber.

### BRIEF DESCRIPTION OF THE DRAWINGS

The present disclosure is explained in more detail with reference to the following figures. Illustrated are:

FIG. 1 shows a cross-sectional view of a potentiometric pH sensor designed as a single-rod measuring chain;

FIG. 2 shows a schematic representation of a pH electrode designed as a single-rod measuring chain with an opening in the outer wall of the reference electrode;

FIG. 3 shows a cross-sectional view of a pressurization chamber; and

FIG. 4 shows a schematic representation of an embodiment of a device according to the present disclosure for producing a pressurized reference electrode.

### DETAILED DESCRIPTION

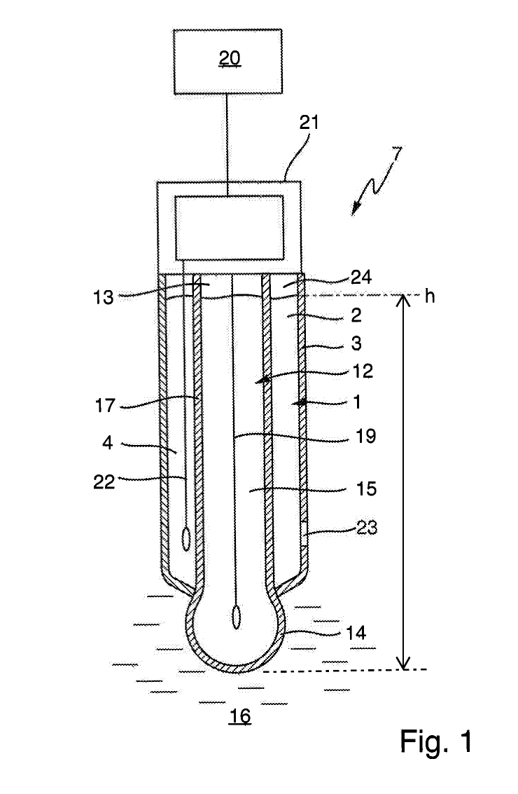

FIG. 1 shows a schematic representation of a potentiometric sensor for pH measurement, which sensor comprises a potentiometric measuring chain, designed as a single-rod measuring chain 7, with a reference half-cell or reference electrode 1 and a measuring half-cell or measuring electrode 12. The pipe-shaped housing wall 17 of the measuring electrode 12 is closed at its end region facing the measuring medium 16 by a pH-sensitive diaphragm 14. The end regions of the measuring electrode 12 facing away from the measuring medium 16 and the reference electrode 1 are closed in a gas-tight manner by means of a sensor head 21, which can also comprise parts of an electronic measuring/evaluation unit 20.

The internal space 13 of the measuring electrode 12 contains an inner electrolyte 15 that comprises a pH buffer system. A deflecting element 19 is immersed in the inner electrolyte 15. The deflecting element 19 is, for example, a chlorinated silver wire. The deflecting element 19 is connected to the electronic measuring/evaluation unit 20, which is either fully or partially located in the sensor head 21 or in a remotely arranged transmitter.

The reference electrode 1 is designed as a silver/silver chloride reference electrode. The internal space 2 of the reference electrode 1 is formed by the housing wall 17 of the measuring electrode 12 and the outer wall 3 of the reference electrode 1. The reference electrode 1 is arranged annularly around the measuring electrode 12. In the end regions facing the pH-sensitive diaphragm 14, the measuring electrode 12 and the reference electrode 1 are connected to one another. The internal space 2 of the reference electrode 1 contains the reference electrolyte 4. The reference electrolyte 4 can comprise a highly concentrated KCl solution with a molar concentration of, for example, 3 M. The reference electrolyte 4 can be thickened by adding a polymer, such as, for example, a polyacrylamide or a slightly cross-linked DADMAC-based gel.

In the reference electrolyte 4, a deflecting element 22 is immersed that can be designed as a chlorinated silver wire, just like the deflecting element 19 of the measuring electrode 12. In the outer wall 3 of the reference electrode 1, a bridge is provided that is designed as, for example, a through-opening or as a porous diaphragm 23. Via the diaphragm 23, the reference electrolyte 4 is in electrolytic contact with the measuring medium 16 in the region of the pH-sensitive diaphragm 14.

The electronic measuring/evaluation unit 20 generates a measurement signal, which represents the pH value of the measuring medium 16, based upon the potential difference picked up between the deflecting element 19 of the measuring electrode 12 and the deflecting element 22 of the reference electrode 1. This measurement signal is forwarded wired or wirelessly via an appropriate connection to a superordinate unit (not shown in FIG. 1). The superordinate unit can be a data processing unit, e.g., a transmitter, a traditional personal computer, or a process control unit, such as a programmable logic controller (PLC).

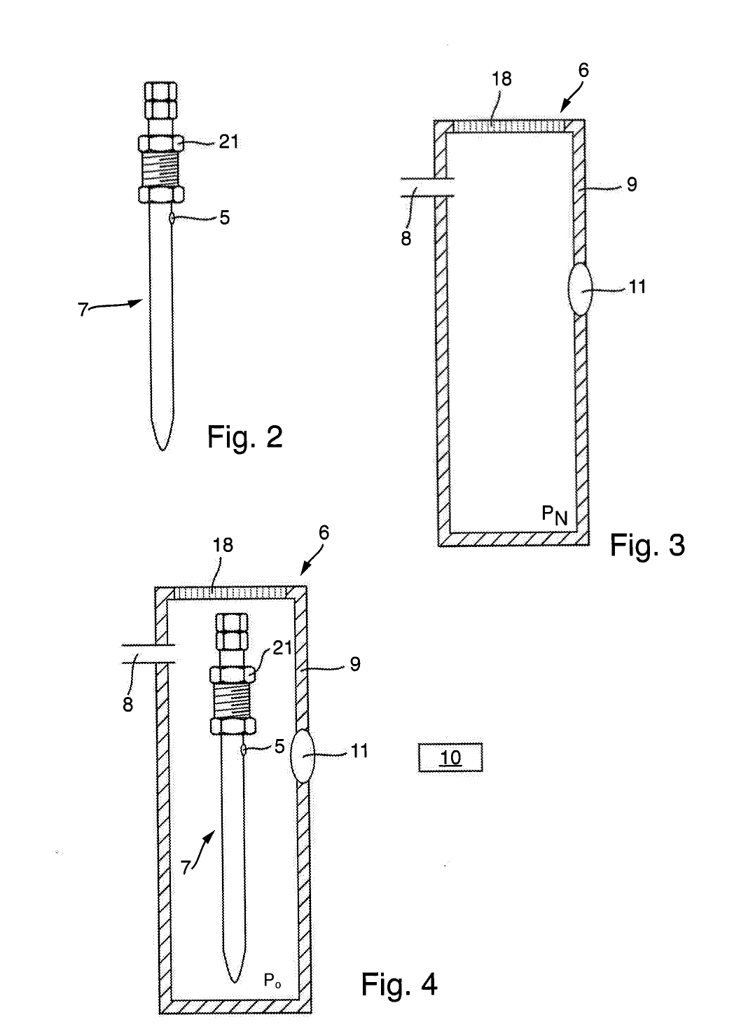

FIG. 2 shows a schematic representation of a pH sensor, designed as a single-rod measuring chain 7, with an opening 5 in the outer wall 3 of the reference electrode 1. A corresponding single-rod measuring chain 7 is illustrated in FIG. 1. Nonetheless, all types of reference electrodes or sensors in which a reference electrode is provided can be pressurized by the method according to the present disclosure and using the device according to the present disclosure.

The pressurization takes place according to the present disclosure via the opening 5 that is provided in the outer wall 3 of the reference electrode 1. This opening 5 is preferably arranged in a region that is not in contact with the reference electrolyte 4 when the single-rod measuring chain 7 is positioned appropriately, for example, upright. In FIG. 1, the filling height of the reference electrolyte 4 is marked h. The opening 5 is thus, preferably, above the filling height h.

The outer wall 3 of the reference electrode 1 preferably consists of plastic or glass. The opening 5 is introduced into the outer wall 3 of the reference electrode 1 by means of one of the known methods. If the outer wall 3 consists of glass, the opening 5 is preferably produced by thermal fusion in the flame or by means of laser.

FIG. 3 shows a schematic representation of a pressurization chamber 6 that can be used in connection with the present disclosure. The appropriately prepared reference electrode 1 (as a component of a single-rod measuring chain 7 in the case shown) is introduced into the pressurization chamber 6 for purposes of pressurization.

FIG. 4 shows a schematic representation of an embodiment of the device according to the present disclosure for producing a pressurized reference electrode 1.

As previously mentioned, the opening 5 can also be produced by thermal fusion, after the single-rod measuring chain 7 has been positioned in the pressurization chamber 6. The fusion takes place, in the case shown, using the laser radiation LS of the laser 10 via a section 11.

As shown in FIGS. 3 and 4, the pressurization chamber 6 consists of a pressure-resistant housing 9 with a removable opening 18 for introducing and removing the sensors. The opening 18 can be mounted to the housing 9 in a pressure-tight manner. Furthermore, a pressure supply 8 or a gas connection for a gas pressure regulator, not shown separately in FIG. 3, is provided on the pressurization chamber 6. The section 11 of the wall of the housing 9 can be designed as an optical window 11. Via the section 11 that is transparent to the laser radiation LS, the laser radiation LS produced by the laser 10 is radiated into the pressurization chamber 8. The laser radiation LS is focused onto the outer wall 3 of the reference electrode 1 in the region of the opening 5.

As soon as the pH sensor is in the pressurization chamber 6 and has the opening 5, the desired overpressure is adjusted in the pressurization chamber 6 via the pressure supply 8. Since the gas-filled space region 24 remaining above the reference electrolyte 4 communicates with the internal space of the pressurization chamber 6 via the opening 5, the adjusted overpressure P_{O} also prevails in the reference electrode 1 after a short dwell time. The opening 5 is then sealed, and thus closed, by means of the focused laser radiation LS. The pressurization chamber 6 is subsequently vented; the pressure is reduced, for example, to atmospheric pressure P_{N}. The pressure previously adjusted via the pressurization chamber 6 continues to prevail in the reference electrode 1. Finally, the pH sensor with the pressurized reference electrode 1, or even the pressurized reference electrode 1 as such, is removed from the pressurization chamber 6.

In summary, the advantages of the method according to the present disclosure or the device according to the present disclosure are as follows:

the pressure in a reference electrode 1 can be adjusted with high precision;

reference electrodes 1 can be produced in a reproducible manner within a very short period of time; and

the production method according to the present disclosure can be automated easily by means of a robot. The accordingly produced reference electrodes 1 are, therefore, cost-effective.

1. A method for producing a reference electrode, comprising:
introducing a reference electrode into a pressurization chamber, the reference electrode including an outer wall at least partially defining an internal space, wherein the internal space contains a reference electrolyte to a specified height within the internal space;
applying a defined overpressure to the pressurization chamber and to the internal space of the reference electrode via an opening in the outer wall of the reference electrode, the opening disposed above the specified height and in communication with the internal space; and
closing the opening when the internal space is at the defined overpressure.

2. The method according to claim 1, the method further comprising generating the opening in the outer wall of the reference electrode by supplying energy selectively.

3. The method according to claim 2, wherein the opening in the outer wall of the reference electrode is generated or closed by thermal fusion or melt-sealing by means of laser radiation or a flame.

4. The method according to claim 1, wherein the opening in the outer wall of the reference electrode is closed by supplying energy selectively.

5. The method according to claim 1, the method further comprising, after closing the opening, venting or reducing the applied to the pressurization chamber to a pressure prevailing in the surroundings of the pressurization chamber.

6. A sensor assembly, comprising a reference electrode, wherein the reference electrode is manufactured by:
introducing the reference electrode into a pressurization chamber, the reference electrode including an outer wall at least partially defining an internal space, wherein the internal space contains a reference electrolyte to a specified height within the internal space;
applying a defined overpressure to the pressurization chamber and to the internal space of the reference electrode via an opening in the outer wall of the reference electrode, the opening disposed above the specified height and in communication with the internal space; and
closing the opening when the internal space is at the defined overpressure.

7. The sensor assembly according to claim 6, wherein the reference electrode is further manufactured by generating the opening in the outer wall of the reference electrode by supplying energy selectively.

8. The sensor assembly according to claim 7, wherein the opening in the outer wall of the reference electrode is generated or closed by thermal fusion or melt-sealing by means of laser radiation or a flame.

9. The sensor assembly according to claim 6, wherein the opening in the outer wall of the reference electrode is closed by supplying energy selectively.

10. The sensor assembly according to claim 6, wherein the reference electrode is further manufactured by, after closing the opening, venting or reducing the pressure applied to the pressurization chamber to a pressure prevailing in the surroundings of the pressurization chamber.

11. The sensor assembly according to claim 6, wherein the reference electrode is made of glass or plastic.

12. The sensor assembly according to claim 6, wherein the sensor assembly is a potentiometric single-rod measuring chain.

13. A device for manufacturing a reference electrode having an opening site, the device comprising:
a pressurization chamber having a housing structured to accept the reference electrode;
a pressure supply configured to apply and adjusted a defined overpressure in the pressurization chamber; and
a laser disposed and focused such that an opening is produced and/or closed at the opening site of the reference electrode by means of laser radiation, wherein the reference electrode is disposed within the pressurization chamber.

14. The device according to claim 13, wherein the laser is arranged outside the housing of the pressurization chamber, and wherein at least one section of the housing of the pressurization chamber is made of a material that is transparent to the laser radiation produced by the laser.

15. The device according to claim 13, wherein the laser is arranged inside the housing of the pressurization chamber.
